(19) United States
(12) Patent Application Publication
(10) Pub. No.: US 2010/0212364 A1
(43) Pub. Date: Aug. 26, 2010

(54) OPTICAL FIBER MANUFACTURING METHODS

(75) Inventors: Takashi SUZUKI, Tokyo (JP); Hiroshi Kuraseko, Tokyo (JP); Nobuaki Orita, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: FURUKAWA ELECTRIC CO., LTD., Tokyo (JP)

(21) Appl. No.: 12/709,681

(22) Filed: Feb. 22, 2010

(30) Foreign Application Priority Data
Feb. 23, 2009 (JP) 2009-039545

(51) Int. Cl. C03B 37/023

(52) U.S. Cl. 65/385

(57) ABSTRACT

An optical fiber manufacturing method, which recycles cooling gas with a simple system (less modification from a conventional device) is provided. The method comprises the steps of heating and melting an optical fiber preform, cooling the glass fiber obtained from the preform using a cooling device, and coating the cooled glass fiber with a coating material. During the cooling step, cooling gas is supplied from the bottom portion of the cooling device 4; a part of the cooling gas in the cooling device 4 is recovered from the top portion of the cooling device 4; and the recovered gas is re-supplied from the bottom portion of the cooling device 4.

### CROSS-REFERENCES TO RELATED APPLICATIONS

This application claims the benefit of priority from Japanese Patent Application No. 2009-039545 filed Feb. 23, 2009, the entire contents of which is incorporated herein by reference.

### TECHNICAL FIELD

The present invention relates to optical fiber manufacturing methods; more particularly, it relates to methods to cool down optical fibers drawn from an optical fiber preform.

### BACKGROUND OF THE INVENTION

A conventional optical fiber manufacturing method is explained using FIG. 1. An optical fiber 30 is manufactured by drawing a glass fiber 3 from an optical fiber preform 1, which is heated and melted in a heating furnace 2. The drawn glass fiber 3 is cooled down to a predetermined temperature using cooling gas in a cooling device 4; coating material is applied to the glass fiber 3 by a die 5; and the coating material is cured by a resin-cure oven 6. Then, the optical fiber 30 is taken up by a take-up winder 8 via capstan 7. The outer diameters of the glass optical fiber 3 and the optical fiber 30 are measured by diameter measurement devices 31, 32 and controlled to have predetermined values. Furthermore, FIG. 1 shows a method for applying the coating material in one operation; however, methods for applying multiple coatings using multiple die 5 are also common.

In the above optical fiber manufacturing method, the cooling gas is supplied to the cooling device 4 from a cooling-gas-supply port 9 to cool down a high temperature glass fiber. Because of its high coefficient of thermal conductivity and its ability to cool down glass fibers in short amount of time, helium is commonly used as the cooling gas.

However, because helium is a relatively expensive gas compared with other gases, several methods to recycle high-purity helium by filtering used helium through filters or refining equipment have been proposed.

For example, U.S. Pat. No. 5,890,376 discloses a method to recover helium used in consolidation process of an optical fiber preform using a helium filter, and recycle the high-purity helium. Also, Japanese Patent Application Laid-open No. 2004-142976 discloses an optical fiber drawing tower, which is equipped with a chassis around an optical fiber cooling pipe of the drawing tower. A gas recovery system is positioned on the top portion of the chassis to recover used helium, and a gas lead-in system is positioned on the bottom portion of the chassis to blow clean air. Used helium is recovered completely in a helium recovery chamber. Then, the recovered gas is purified using a filter or refining equipment and recycled. However, the methods disclosed in U.S. Pat. No. 5,890,376 and Japanese Patent Application Laid-open No. 2004-142976 require large complicated systems, and lead to high initial investment and maintenance fees. Therefore, other significant costs are incurred when recycling is used to reduce the cost of helium.

### SUMMARY OF THE INVENTION

The present invention discloses an optical fiber manufacturing method, which recycles cooling gas (such as helium) with a simple system (less modification from a conventional device).

To solve the problem stated above, an optical fiber manufacturing method according to the present invention comprises the steps of heating and melting an optical fiber preform, cooling a glass fiber obtained from the preform using a cooling device, and coating the cooled glass fiber with a coating material. During the cooling step, cooling gas is supplied from the bottom portion of the cooling device; a part of cooling gas in the cooling device is recovered from the top portion of the cooling device; and the recovered gas is re-supplied from the bottom portion of the cooling device.

### BRIEF DESCRIPTION OF THE DRAWINGS

Referring now to the drawings:

FIG. 1 is a schematic view of a conventional optical fiber manufacturing device;

FIG. 2 is a schematic view of one embodiment of an optical fiber cooling system, which is related to the optical fiber manufacturing method of the present invention; and

FIG. 3 is a chart, which shows relationships among the amount of the recovered gas (the amount of the circulating gas), the amount of the supplied high-purity helium, the amount of the ambient air in the recovered gas, and the recycle rate of helium in one embodiment of the present invention.

### DETAIL DESCRIPTION

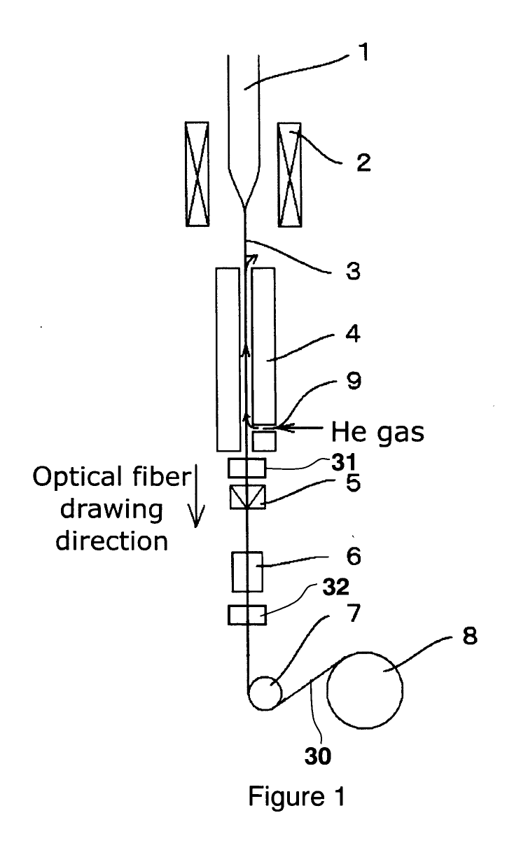

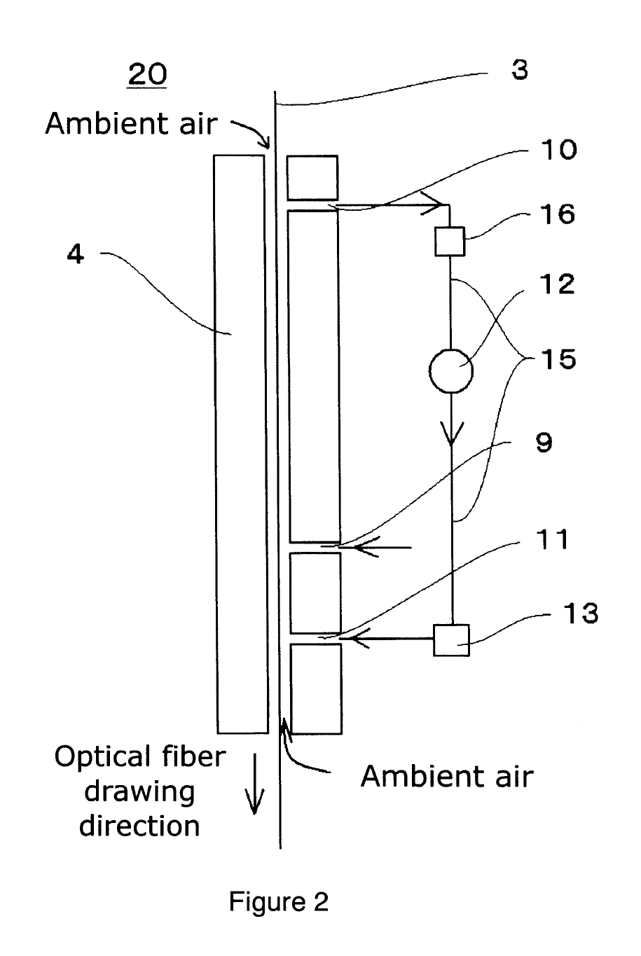

The optical fiber manufacturing methods of the present invention are similar to the conventional optical fiber manufacturing method explained in FIG. 1, except for a process to cool down optical fibers. Below, the process for cooling an optical fiber according to the present invention is explained in detail. FIG. 2 is a schematic drawing of an optical fiber cooling system 20 according to the present invention. Immediately after drawing, a high temperature glass fiber 3 passes through a cooling device 4. The cooling device 4 has a cooling-gas-supply port 9, which supplies high-purity helium as a cooling gas at the bottom portion of the cooling device 4. Most of the supplied helium exchanges heat with the high temperature glass fiber as the gas travels to the upper portion of the cooling device; and therefore, the glass optical fiber is cooled down.

The amount of the high-purity helium supplied from the cooling gas supply port is controlled by a mass flow controller (MFC), which is not shown in the Figures. In this specification, high-purity helium gas is approximately 99.997% pure, and is supplied from commercially available industrial-use gas cylinders, girdles or roll; or in some cases, high-purity helium gas is purified to have the same or higher purity than 99.997% by refining equipment. Moreover, helium, which is used in other processes and highly purified by refining equipment, can be used as the high-purity gas.

The cooling device 4 is equipped with a cooling-gas-recovery port 10 at the top portion of the cooling device 4 to recover a part of the cooling gas within the cooling device 4. Then the recovered gas is re-supplied from a circulating-gas-supply port 11 at the bottom portion of the cooling device 4 without the circulating gas being highly-purified. The circulating gas contains high-purity helium supplied from the cooling gas supply port. Therefore, from the bottom portion of the cooling device 4, high-purity helium gas is supplied from the cooling-gas-supply port 9, and the circulating gas is supplied from the circulating-gas-supply port 11.

The cooling device 4 is equipped with a circulation pipe 15, and the circulation pipe 15 has a MFC 13 and a pump 12 to act as a gas supply unit. The part of the cooling gas is recovered by the pump 12 while the amount of the gas to be recovered is controlled by the MFC 13, and then the recovered gas is re-supplied in the cooling device 4 by flowing through the circulation pipe. At this time, the amount of the recovered gas and the amount of the re-supplied circulating gas are approximately the same.

After the glass fiber is cooled down by the cooling device 4, the glass fiber is covered with a coating; and the outer diameter is measured by diameter measurement devices 32. The outer diameter of the coating changes with the temperature of the glass fiber. For example, if the temperature of the glass fiber is relatively high, then the amount of the coating material that attaches to the fiber is relatively small, and therefore the outer diameter of the coating is relatively small; but if the temperature of the glass fiber is relatively low, then the amount of the coating material that attaches to the fiber is relatively large, and therefore the outer diameter of the coating is relatively large. Thus, it is common to control the outer diameter of coated optical fiber by performing the cooling control of the glass fiber.

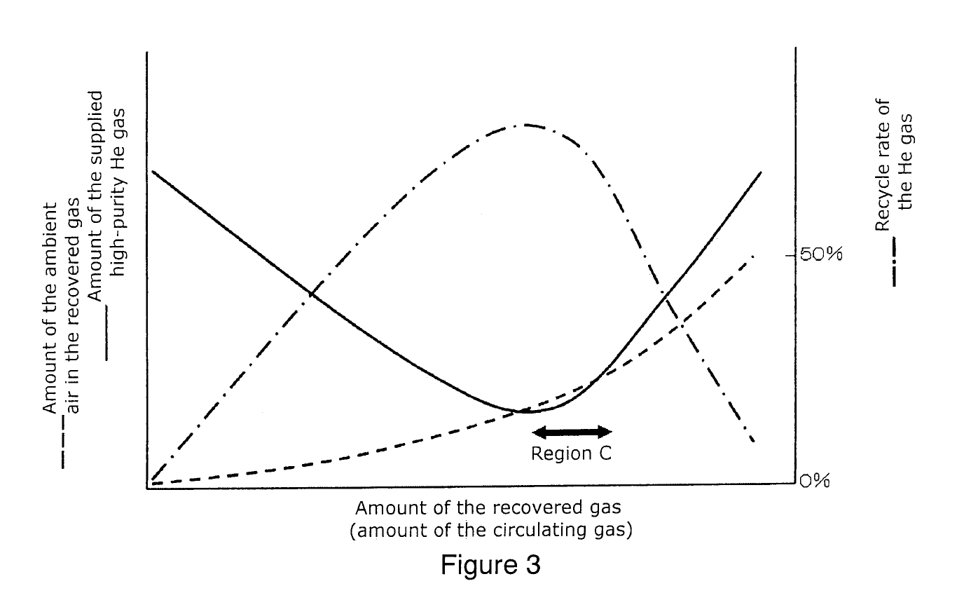

In terms of cost reduction, it is preferable to recover a large amount of the cooling gas; however, if the amount of the recovered gas is too large, the amount of the ambient air in the recovered gas increases, then the cooling effect to the glass fiber is inadequate. Consequently, by using the optical fiber cooling system 20 shown in FIG. 2, the amount of the supplied high-purity helium, the amount of the ambient air in the recovered gas, and the recycling rate of helium are studied while keeping the outer diameter of the coated optical fiber at a predetermined value and increasing the recovered amount of the cooling gas. FIG. 3 shows the relationship among the amount of the recovered cooling gas (amount of the circulating gas) and the amount of the supplied high-purity helium, the amount of ambient air in the recovered gas, and the recycle rate of helium gas according to the study.

The amount of the ambient air in the recovered gas is a value determined by the oxygen concentration in the recovered gas by an oxygen meter positioned in the circulation pipe near the cooling gas recovery port. In FIG. 3, the x-axis is the amount of the recovered cooling gas (amount of the circulating gas); and the y-axes are the amounts of high-purity helium, the amount of the ambient air in the recovered gas, and the recycle rate of helium. The recycle rate of helium is calculated using the following equation:

(A−B)/A×100 (1)

Where A is amount of the high-purity helium when the cooling gas is not recovered from the cooling-gas-recovery port 10, and when the high-purity gas alone is supplied to the cooling device 4 to obtain the predetermined outer diameter of the coated optical fiber; and B is amount of the high-purity helium when the part of the cooling gas is recovered from the cooling-gas-recovery port 10 to obtain the predetermined outer diameter of the coated optical fiber.

The far left of the x-axis of FIG. 3 represents the amount of the high-purity helium from the cooling-gas-supply port 9 when no cooling gas is recovered from the cooling-gas-recovery port 10. As shown in FIG. 3, when the amount of the recovered cooling gas is increased, the outer diameter of the coated optical fiber can be kept at the predetermined value while reducing the amount of the high-purity helium from the cooling-gas-supply port 9; and therefore, the helium recycle rate increases.

However, as the amount of the recovered cooling gas from the circulating-gas-supply port 11 increases, the amount of the ambient air in the recovered gas also increases. If the amount of the recovered gas increases even further, the supplied amount of the high-purity helium needs to be increased in order to keep the outer diameter of the coated optical fiber at the predetermined value.

As the amount of the ambient air in the recovered gas increases, the concentration of helium inside the cooling device decreases, which leads to inadequate cooling of the glass fiber; and therefore the supply amount of the high-purity helium needs to be increased in order to maintain the predetermined outer diameter of the coated optical fiber. For this reason, if the amount of the recovered cooling gas is too large, the recycle rate of helium decreases. This phenomenon occurs when the amount of the recovered cooling gas is increased from the point where the supplied amount of the high-purity helium and the ambient air in the recovered gas are approximately the same (the difference is less than 1 L/minute).

The outer diameter of the coated optical fiber is unstable and difficult to control in region C, shown in FIG. 3, wherein the amount of the supplied high-purity helium and the amount of the ambient air in the recovered gas are approximately the same (the difference is less than 1 L/minute). This occurs because the balance of supplied gas and the recovered gas leads to a reverse flow of gas in the cooling device. In other words, in a typical cooling device, gas flows from bottom to top, but reverse flow causes gas to flow from top to bottom. However, if the amount of the recovered cooling gas increases after the region C, then reverse flow in the cooling device does not occur and the gas in the cooling device flows from bottom to top stably.

From the above results, if the amount of the recovered cooling gas is controlled such that the amount of the ambient air in the recovered gas and the supplied amount of the high-purity helium are different, then reverse flow in the cooling device does not occur. Also, if the amount of the recovered cooling gas is lower than the amount in the region C, then the amount of the supplied high-purity helium can be reduced. Furthermore, if recycle rate of high-purity helium gas is between 10% and 80%, then a stable outer diameter of the optical fiber can be achieved with reducing the amount of the high-purity helium.

In the present invention, it is preferable to control the amount of the high-purity helium supplied from the cooling-gas-supply port 9 while keeping the amount of the recovered cooling gas constant in order to simplify control and obtain a stable predetermined outer diameter of the coated optical fiber. Factors such as drawing speed and room temperature change the amount of ambient air in the recovered gas—even if the same amount of the cooling gas is recovered. Therefore, if the amount of the recovered cooling gas is controlled, then the number of variables that affect the outer coating diameter will increase, thereby increasing the ability to vary the outer diameter of the coated optical fiber. If the amount of the supplied high-purity helium is controlled while keeping the amount of the recovered cooling gas constant to obtain the predetermined outer coating diameter, then it can adjust to the change in the amount of the cooling gas recovered, so there is no need to control the amount of the recovered cooling gas during an operation, which leads to a simple control system.

The above embodiment discloses a case before coating the glass fiber; however, the present invention is also applicable to cooling a coated optical fiber. In the cooling of a coated optical fiber, it is also preferable to control the amount of the recovered gas such that the amount of the ambient air in the recovered gas is lower than the amount of the supplied high-purity helium. Furthermore, the circulation pipe 15 can be equipped with a cooling device to cool down the recovered cooling gas. In this case, the amount of the high-purity helium can be further reduced by increasing the cooling efficiency of the cooling device 4.

### EMBODIMENT

As an embodiment, a glass fiber is cooled down and a coating layer is applied by using the optical fiber cooling system disclosed in FIG. 2. The results are shown below. In this embodiment, the amount of the high-purity helium is controlled while keeping the amount of the recovered cooling gas constant in order to obtain a predetermined outer diameter of the coated optical fiber. Also, the speed of optical fiber drawing is 1200 m/minute.

If no cooling gas is recovered from the cooling-gas-recovery port 10, then the predetermined outer diameter of the optical fiber is obtained when the high-purity helium is supplied 29 L/minute from the cooling gas supply port. If the amount of the recovered cooling gas increases to 20, 35, 50 or 60 L/minute, then the supplied amount of the high-purity helium from the cooling-gas-supply port 9 is 18, 13, 12 or 23 L/minute respectively to obtain the predetermined outer diameter of the optical fiber. Also, the amount of the recovered cooling gas is approximately 50 L/minute when the amount of the ambient air in the recovered gas is approximately equal to the amount of the high-purity helium (region C in FIG. 3). However, if the amount of the recovered cooling gas is 50 L/minute, then the outer diameter of the optical fiber becomes unstable because of the lack of control in managing the outer diameter of the optical fiber. If the amount of the recovered cooling gas is 20, 35 or 60 L/minute, then stable manufacturing is achieved while recycling helium. Also, the corresponding recycle rate of helium is 38, 65 or 22%.

Therefore, if the amount of the recovered cooling gas is less than 50 L/minute or more than 50 L/minute, then a stable outer diameter of the optical fiber is achieved while recycling helium. However, because the recycle rate of helium decreases rapidly in the area where the amount of the recovered cooling gas exceeds 50 L/minute, it is preferable to recover cooling gas at the amount less than 50 L/minute. Also, the preferred amount of the recovered cooling gas may change depending on factors such as the size of the device. The preferred amount of the recovered cooling gas for a specific device can be determined by performing the experiment shown above and creating a chart similar to the one in FIG. 3.

What is claimed is:

1. A method for manufacturing an optical fiber comprising the steps of:
heating and melting an optical fiber preform;
cooling a glass fiber obtained from the preform using a cooling device; and
coating the cooled glass fiber with a coating material to make the optical fiber;
wherein, during the cooling step, cooling gas is supplied from a bottom portion of the cooling device; a part of the cooling gas in the cooling device is recovered from a top portion of the cooling device; and the recovered gas is re-supplied from the bottom portion of the cooling device.

2. The method of claim 1, wherein the amount of the supplied cooling gas is controlled to obtain a predetermined outer diameter of the optical fiber after the coating step while keeping the amount of the recovered gas constant.

3. The method of claim 1, further comprising:
measuring oxygen concentration in the recovered gas; and
calculating an amount of ambient air in the recovered gas from the oxygen concentration;
wherein the amount of the recovered gas is set such that the amount of the ambient air in the recovered gas and the amount of the supplied cooling gas are different.

4. The method of claim 3, wherein the amount of the recovered gas is set less than the amount of the recovered gas when the amount of the ambient air in the recovered gas and the amount of the supplied cooling gas are approximately the same.

5. The method of claim 1, wherein a recycle rate of the cooling gas is between 10% and 80%, wherein the recycle rate of the cooling gas is calculated using the following equation:
(A−B)/A×100
where A is an amount of the cooling gas when the cooling gas alone is supplied to the cooling device to obtain a predetermined outer diameter of the optical fiber; and B is an amount of the cooling gas when the cooling gas is recovered to obtain the predetermined outer diameter of the optical fiber.
